(19) United States
(12) Patent Application Publication
(10) Pub. No.: US 2024/0208621 A1
(43) Pub. Date: Jun. 27, 2024

(54) BATTERY SYSTEM AND HULL ASSEMBLY

(71) Applicant: A.P. Møller - Maersk A/S, Copenhagen K (DK)

(72) Inventor: Morten VEJLGAARD-LAURSEN, Copenhagen K (DK)

(21) Appl. No.: 18/557,270

(22) PCT Filed: Apr. 29, 2022
(86) PCT No.: PCT/EP2022/061433

§ 371 Date: Oct. 25, 2023

(30) Foreign Application Priority Data
Apr. 30, 2021 (DK) PA202100446

(51) Int. Cl. B63B 39/03; H01M 8/04082; H01M 8/04186; H01M 8/18

(52) U.S. Cl. CPC B63B 39/03; H01M 8/04186; H01M 8/04201; H01M 8/188; H01M 2250/20

(57) ABSTRACT

Disclosed is a battery system for a marine vessel, the marine vessel comprising a hull. The battery system comprises a flow battery comprising an ion exchange element, and a first ballast tank for location in the hull and defining a first ballast tank chamber for storing electrolyte for the flow battery.

### TECHNICAL FIELD

The present invention relates to battery systems for marine vessels, to hull assemblies, and to methods of changing attitudes of marine vessels.

### BACKGROUND

Marine vessels, such as container ships, have systems that consume electrical energy, such as control systems of the marine vessel, engine management systems, heating and lighting systems, and fluid systems comprising hydraulic pumps, such as fuel systems for engines of the marine vessel. The electricity for such systems is typically provided by electrical power generators of the marine vessel, in some examples by consuming fuel, or by a power grid or external power generator, such as during a port stay.

### SUMMARY

A first aspect of the present invention provides a battery system for a marine vessel, the marine vessel comprising a hull, the battery system comprising: a flow battery comprising an ion exchange element; and a first ballast tank for location in the hull and defining a first ballast tank chamber for storing electrolyte for the flow battery.

By storing the electrolyte for the flow battery in a ballast tank for location in the hull, the flow battery may take up a smaller physical footprint in the marine vessel, as it may not require extra storage space for the electrolyte. In this way, a larger flow battery may be installed. The battery system may also keep low a weight of the marine vessel, as the electrolyte can replace ballast water that might otherwise be stored in the marine vessel. This may allow the marine vessel to carry more cargo, reduce an operating cost of the marine vessel and/or reduce emissions from the marine vessel. This may be particularly beneficial during a port stay, where the electrical energy stored in the battery system may be used to power electrical systems of the marine vessel without requiring operation of the engines of the marine vessel.

Optionally, the first ballast tank comprises an electrically insulative interior defining the first ballast tank chamber for storing the electrolyte. Optionally the electrically insulative interior of the first ballast tank is a polymeric interior, or an electrically insulative interior coating of the first ballast tank. In this way, there may be a reduced risk of corrosion of the interior of the first ballast tank in the presence of the electrolyte stored in the first ballast tank chamber in use.

Optionally, the battery system comprises a first feed conduit through which the electrolyte is flowable from the first ballast tank chamber to the ion exchange element.

That is, the first feed conduit may be fluidically connected, or connectable, between the first ballast tank chamber and the ion exchange element, or a part thereof.

Optionally, the battery system comprises: a second ballast tank for location in the hull and defining a second ballast tank chamber for storing electrolyte for the flow battery; and a first conduit arrangement through which electrolyte is flowable from the first ballast tank chamber to the second ballast tank chamber.

In this way, the flow battery can be used to both store and provide electrical energy for use on the marine vessel and to control an attitude, or a stability, of the marine vessel by passing electrolyte from the first ballast tank chamber to the second ballast tank chamber. That is, the battery system can serve two purposes, and may partially replace a water ballast system of the marine vessel. In this way, the battery system may provide the benefits of an electrical energy storage system without significantly impacting on the weight of the marine vessel.

Optionally, the second ballast tank comprises an electrically insulative interior defining the second ballast tank chamber for storing the electrolyte. Optionally the electrically insulative interior of the second ballast tank is a polymeric interior, or an electrically insulative interior coating of the second ballast tank.

Optionally, the first conduit arrangement comprises the first feed conduit and a second feed conduit, and the ion exchange element is fluidically connected or connectable to the first and second ballast tank chambers by the respective first and second feed conduits.

Optionally, the ion exchange element is fluidically connected or connectable to the first and second feed conduits in such a way that electrolyte is flowable from one of the first and second ballast tank chambers to the other of the first and second ballast tank chambers via the ion exchange element.

Optionally, the ion exchange element comprises a first ion exchange chamber and a second ion exchange chamber separated from each other by an ion exchange interface, and wherein the first ion exchange chamber is fluidically connected or connectable to the first ballast tank chamber and the second ballast tank chamber by the respective first and second feed conduits.

In this way, the electrolyte may be flowable through the first ion exchange chamber from either or both of the first and second ballast tank chambers in order to charge or discharged the electrolyte stored in the respective first and second ballast tank chambers.

Optionally, the first conduit arrangement comprises a first transfer conduit configured so that electrolyte is flowable from the first ballast tank chamber to the second ballast tank chamber without passing through the ion exchange element.

In this way, the battery system is operable to change an attitude of the marine vessel, such as by redistributing the electrolyte, and the weight thereof, between the first and second ballast tank chambers, without also operating the flow battery to charge and/or discharge the electrolyte.

Optionally, the battery system comprises a first flow moving device operable to move electrolyte along the first conduit arrangement from the first ballast tank chamber to the second ballast tank chamber.

Optionally, the first flow moving device is operable to move electrolyte reversibly along the first conduit arrangement from the first ballast tank chamber to the second ballast tank chamber. In this way, the battery system may reversibly change an attitude of the marine vessel, and/or may pass the electrolyte back and forth through the ion exchange element multiple times to charge and/or discharge the electrolyte.

Optionally, the first conduit arrangement is configurable such that electrolyte is flowable from one of the first and second ballast tank chambers to the other of the first and second ballast tank chambers via the ion exchange element.

Optionally, the battery system comprises: a third ballast tank and a fourth ballast tank, each for location in the hull and defining respective third and fourth ballast tank chambers for storing electrolyte for the flow battery. Optionally, the battery system comprises a second conduit arrangement through which electrolyte is flowable between the third ballast tank chamber and the fourth ballast tank chamber. Optionally, the second conduit arrangement comprises a second transfer conduit configured so that electrolyte is flowable between the third ballast tank chamber and the fourth ballast tank chamber without passing through the ion exchange element.

Optionally, the battery system comprises a second flow moving device operable to move electrolyte along the second transfer conduit from the third ballast tank chamber to the fourth ballast tank chamber.

Optionally, the second conduit arrangement comprises a third feed conduit and a fourth feed conduit, and the ion exchange element is fluidically connected or connectable to the third and fourth ballast tank chambers by the respective third and fourth feed conduits. Optionally, the ion exchange element is fluidically connected or connectable to the third and fourth feed conduits in such a way that electrolyte is flowable from one of the third and fourth ballast tank chambers to the other of the third and fourth ballast tank chambers via the ion exchange element.

Optionally, the second ion exchange chamber is fluidically connected or connectable to the third ballast tank chamber and the fourth ballast tank chamber by the respective third and fourth feed conduits.

A second aspect of the present invention provides a hull assembly for a marine vessel, the hull assembly comprising a hull and the battery system of the first aspect, wherein the first ballast tank is located in the hull.

By storing the electrolyte in the hull, rather than elsewhere, for example vertically higher in the marine vessel, the marine vessel may maintain a lower centre of mass, thereby maintaining or improving a stability of the vessel.

Optionally, the battery system comprises the second ballast tank, and the second ballast tank is located in the hull, and the first and second ballast tanks are located at opposite lateral sides of the hull or at opposite longitudinal ends of the hull.

In this way, electrolyte may be moved from one side/end of the hull to the opposite side/end of the hull to redistribute a weight of the marine vessel and control an attitude of the marine vessel. This may be to correct, or set, a trim of the marine vessel, such as during a voyage, or during a loading and/or unloading of cargo during a port stay.

Optionally, the hull has inner and outer skins defining first and second hull spaces on the opposite sides/ends of the hull, and the first and second ballast tanks are located in the respective first and second hull spaces.

In this way, the first and second ballast tanks may utilise space in the hull that is not used for storing cargo, which may allow the marine vessel to carry more cargo.

Optionally, the hull assembly comprises more than one such flow battery.

A third aspect of the present invention provides a marine vessel comprising the battery system according to the first aspect and/or the hull assembly according to the second aspect.

A fourth aspect of the present invention provides a method of changing an attitude of a marine vessel, the marine vessel comprising a hull, a flow battery, and first and second ballast tank chambers in the hull, the method comprising moving electrolyte for the flow battery from the first ballast tank chamber to the second ballast tank chamber.

Optionally, the flow battery comprises an ion exchange element. Optionally the method comprises discharging the flow battery by electrically connecting the ion exchange element to an electrical load, such as an electrical system of the marine vessel. Optionally, the method comprises charging the flow battery by electrically connecting the ion exchange element to an electrical supply, such as a power generator of the marine vessel, or an electrical grid, such as during a port stay. Optionally, the ion exchange element comprises electrodes and the method comprises connecting the electrical load and/or the electrical supply to the electrodes.

Optionally, the method comprises moving electrolyte from one or both of the first and second ballast tank chambers to the ion exchange element and back to a respective one or both of the first and second ballast tank chambers. This may be to charge and/or discharge the flow battery.

Optionally, the moving electrolyte for the flow battery from the first ballast tank chamber to the second ballast tank chamber comprises moving, for example using a first flow moving device, the electrolyte from the first ballast tank chamber to the second ballast tank chamber via a transfer conduit that is configured so that electrolyte is flowable from the first ballast tank chamber to the second ballast tank chamber without passing through the ion exchange element. Optionally, the moving electrolyte for the flow battery from the first ballast tank chamber to the second ballast tank chamber comprises moving the electrolyte from the first ballast tank chamber to the second ballast tank chamber via the ion exchange element.

Optionally, the method comprises bunkering and/or debunkering electrolyte from the first and/or second ballast tank chambers.

Optionally, the method comprises any of the above-described actions performed in relation to the battery system of the first aspect. Optionally, the battery system is the battery system of the first aspect. Optionally, the hull is the hull comprised in the hull assembly of the second aspect. Optionally, the marine vessel is the marine vessel of the third aspect.

### BRIEF DESCRIPTION OF THE DRAWINGS

Embodiments of the invention will now be described, by way of example only, with reference to the accompanying drawings, in which:

FIG. 1 shows a schematic plan view of an example of a marine vessel;

FIG. 2 shows a schematic cross-sectional view of an example of the marine vessel;

FIG. 3 shows a schematic diagram of an example battery system; and

FIG. 4 shows a schematic flow diagram of an example method.

### DETAILED DESCRIPTION

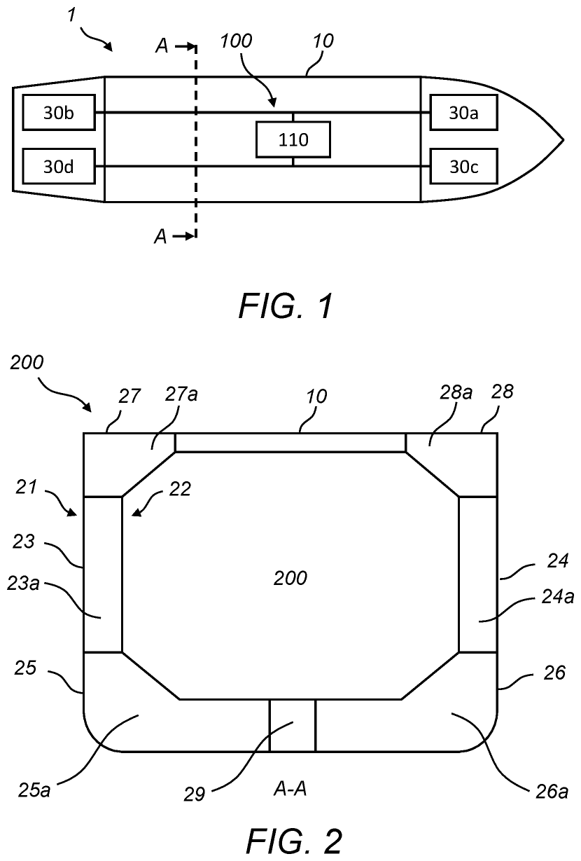

FIG. 1 shows a schematic top view of an example of a marine vessel 10 according to an example of the present invention. In this example, the marine vessel 10 is a container ship. In other examples, the marine vessel 10 is another form of cargo vessel, such as a tanker, a dry-bulk carrier or a reefer ship, or a passenger vessel. In other examples, the marine vessel is any other water-going vessel, such as a tugboat, or a recreational boat, such as a yacht.

The marine vessel 1 comprises a hull 10 and a battery system 100 in the hull 10. The hull 10 and the battery system 100 together form at least a part of a hull assembly. The battery system 100 comprises a flow battery 110 and a plurality of ballast tanks 30a-30b located in the hull 10. Specifically, in the illustrated example, the battery system 100 comprises first to fourth ballast tanks 30a, 30b, 30c, 30d. The first and third ballast tanks 30a, 30c are located at a bow (front end) of the hull 10, and the second and fourth ballast tanks 30b, 30d are located at a stern (rear end) of the hull 10. In other words, in the illustrated example, the battery system 100 comprises ballast tanks 30a-30d located at opposite ends of the hull 10 in a longitudinal direction of the hull 10.

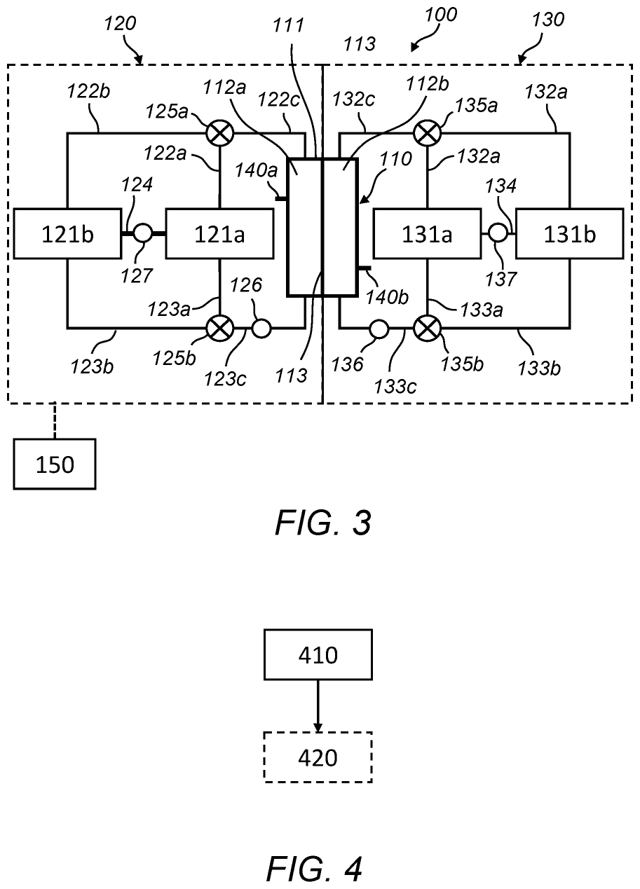

The ballast tanks 30a-30d are each fluidically connected, or connectable, to the flow battery 110. As will be described in more detail hereinafter with reference to FIGS. 3 and 4, the battery system 100 is configured to store electrical energy in the form of a charged electrolyte contained in the ballast tanks 30a-30d. The charged electrolyte is flowable through the flow battery 110, specifically through an ion exchange element (described in more detail hereinafter) of the flow battery 110, to provide electrical energy for electrical systems of the marine vessel 1.

In the illustrated example, the first ballast tank 30a is fluidically connected, or connectable, to the second ballast tank 30b, so that electrolyte is flowable between the first and second ballast tanks 30a-30b. Likewise, the third ballast tank 30c is fluidically connected, or connectable, to the fourth ballast tank 30d, so that electrolyte is flowable between the third and fourth ballast tanks 30c-30d. In this way, electrolyte is passable between the respective ballast tanks 30a-30d, to control a stability of, such as to change an attitude of, the marine vessel 1.

Specifically, in the present example, electrolyte is passable between the first and second ballast tanks 30a, 30b, and/or between the third and fourth ballast tanks 30c, 30d, to move the electrolyte fore and aft of the marine vessel 1. In this way, the battery system 100 can be used to control a pitch of the marine vessel 1. In other examples, the electrolyte is stored in, and is passable between, ballast tanks located at opposite lateral sides of the hull 10. In this way, the battery system 100 can be used to control a heel of the marine vessel 1. That is, in some examples, the battery system 100 is used to trim the marine vessel 1 by passing electrolyte between the ballast tanks 30a-30d on opposite lateral and/or longitudinal sides of the hull 20 to control a pitch and/or a heel of the marine vessel 1.

FIG. 2 shows a cross-sectional schematic view of the marine vessel 1 along the dashed line labelled A-A in FIG. 1. As shown in FIG. 2, the hull 10 comprises a cargo space 200 for storing cargo. In the illustrated example, the hull 10 comprises a double-hull construction comprising an inner skin 21 and an outer skin 22. The inner skin 21 and outer skin 22 together define plural ballast or void spaces in the hull. Specifically, the hull 10 of the present example comprises a port ballast space 23 on a port side of the hull 10 and a starboard ballast space 24 on a starboard side of the hull 10. The hull 10 also comprises a port and starboard double ballast spaces 25, 26 at a lower side of the hull, and port and starboard top void spaces 27, 28 at an upper side of the hull 10. The void spaces 27, 28 are, in some examples, spaces of the hull not otherwise occupied by ballast tanks, cargo, or components of the marine vessel 1, but which may, in other examples, comprise, or be retrofitted with, ballast tanks.

In the illustrated example, the hull 10 comprises a cofferdam 29 separating the port and starboard double ballast spaces 25, 26. In some examples, the cofferdam 29 comprises components of the marine vessel 1, such as components of the flow battery 110, such as fluid conduits, filters, pumps and/or other components for moving electrolyte between the ballast tanks 30a-30d, as will be described hereinafter.

Each of the port and starboard ballast spaces 23, 24 defines a respective ballast chamber 23a, 24a. In other words, the walls of the port and starboard ballast spaces 23, 24 in the present example define respective ballast tanks 23, 24 enclosing respective ballast tank chambers 23a, 24a. In other examples, though not shown here, each of the port and starboard ballast spaces 23, 24 comprises a separate ballast tank located therein, and the separate ballast tanks define the respective ballast tank chambers 23a, 24a. Similarly, the port and starboard double ballast spaces 25, 26 define, or comprise, respective port and starboard double ballast tanks defining respective port and starboard double ballast tank chambers 25a, 26a. In some examples, the top port and starboard void spaces 27, 28 comprise respective port and starboard top ballast tanks defining respective port and starboard top ballast chambers 27a.

It will be appreciated that any one of the ballast chambers 23a-28a shown and described in FIG. 2 may be fluidically connected, or connectable, to any other one of the ballast chambers 23a-28a. It will also be appreciated that, in some examples, the battery system 100 comprises any one of the ballast tanks 23a-28a shown and described in FIG. 2. For example, the first and third ballast tanks 30a, 30c may instead, or in addition, be defined by, or located in, one of the port and starboard ballast spaces 23, 24, and the second and fourth ballast tanks 30b, 30d may instead, or in addition, be defined by, or located in, the other one of the port and starboard ballast spaces 23, 24. In other examples, any one of the first to fourth ballast tanks 30a-30d is defined by, or located in, any one of the port and starboard double ballast spaces 25, 26 or port and starboard void spaces 27, 28. In other examples, the hull 10 comprises fore ballast spaces (not shown) at the bow (front end) of the hull 10, the fore ballast spaces defining, and/or comprising, the first and third ballast tanks 30a, 30c. In some such examples, the hull 10 comprises aft ballast spaces (not shown) at a stern (rear end) of the hull 10, the aft ballast spaces defining, and/or comprising, the second and fourth ballast tanks 30b, 30d. In other words, the ballast tanks 30a-30d of the battery system 100 may be located in any suitable part of the hull 10 in order to provide a desired stability and/or attitude control of the marine vessel 1.

Example configurations of the battery system 100 are now described in more detail with reference to FIGS. 3 and 4.

FIG. 3 shows a schematic diagram of a first example of the battery system 100. The ballast tanks 30a, 30b, 30c, 30d of the battery system 100 define respective ballast tank chambers 121a, 121b, 131a, 131b. Specifically, the first ballast tank 30a defines a first ballast tank chamber 121a, the second ballast tank 30b defines a second ballast tank chamber 121b, the third ballast tank 30c defines a third ballast tank chamber 131a and the fourth ballast tank 30d defines a fourth ballast tank chamber 131b. In some examples, the first to fourth ballast tank chambers 121a, 121b, 131a, 131b may be any one of the ballast tank chambers 23a-26a shown and described with reference to FIG. 2.

The electrolyte stored in the first to fourth ballast tank chambers 121a, 121b, 131a, 131b in use comprises vanadium, such as vanadium in a solution of sulfuric acid. As such, each of the ballast tanks 30a-30d comprises an electrically insulative interior defining the respective ballast tank chambers 121a, 121b, 131a, 131b for storing the electrolyte. This may reduce a risk of an electrical charge being developed between the electrolyte and the interiors of the respective ballast tanks 30a-30d and/or to reduce a risk of corrosion of the interiors of the respective ballast tanks 30a-30d. In the present example, the electrically insulative interiors of the respective ballast tanks 30a-30d are polymeric interiors. Specifically, each of the ballast tanks 30a-30d is constructed of a polymeric material and is located in any one of the ballast spaces 23-26 or void spaces 27-28 described hereinbefore with reference to FIG. 2. In other examples, each ballast tank 30a-30d is defined by a respective ballast space 23-26, and the ballast space 23-26 comprises an electrically insulative interior coating, such as an epoxy coating or any other suitable coating. In other examples, each of the ballast tanks 30a-30d comprises an electrically conductive interior surface. In other examples, the electrolyte is any other suitable electrolyte for a flow battery, such as a zinc and/or a bromine-based electrolyte.

As shown in FIG. 3, the first and second ballast tank chambers 121a, 121b are fluidically connected, or connectable, to the flow battery 110 by a first conduit arrangement 120. Similarly, the third and fourth ballast tank chambers 131a, 131b are fluidically connected, or connectable, to the flow battery 110 by a second conduit arrangement 130.

The flow battery 110 comprises an ion exchange element 111 comprising a first ion exchange chamber 112a and a second ion exchange chamber 112b separated from each other by an ion exchange interface 113. In the present example, the ion exchange interface 113 is an ion exchange membrane configured to permit electrically charged ions to flow from an electrolyte in one of the first and second chambers 112a, 112b to an electrolyte in the other of the first and second ion exchange chambers 112a, 112b in use. In other examples, the ion exchange interface 113 is a fluid-fluid interface between two electrolytes flowing in a laminar flow regime through the ion exchange element 111.

In the present example, the first and second ballast tank chambers 121a, 121b comprise a positively charged electrolyte, or a “catholyte”, in use, and the third and fourth ballast tank chambers 131a, 131b comprises a negatively charged electrolyte, or an “anolyte”, in use. In other examples, the first and second ballast tank chambers 121a, 121b store an anolyte and the third and fourth ballast tank chambers 131a, 131b store a catholyte.

The catholyte stored in the battery system 100 is flowable through one of the first and second ion exchange chambers 112a, 112b, such as via a respective one of the first and second conduit arrangements 120, 130, and the anolyte stored in the battery system 110 is flowable through the other of the first and second ion exchange chambers 112a, 112b, such as via the other of the first and second conduit arrangements 120, 130. As the positively and negatively charged electrolytes flow in the respective first and second ion exchange chambers 112a, 112b in use, ions from the respective electrolytes are exchanged across the ion exchange interface 113. The exchange of charged ions across the ion exchange interface 113 causes the charged anolyte and catholyte to discharge, thereby generating electrical power.

The ion exchange element 111 comprises a first electrode 140a, such as a cathode, exposed to the first ion exchange chamber 112a and the catholyte contained therein in use, and a second electrode 140b, such as an anode, exposed to the second ion exchange chamber 112b and the anolyte contained therein in use. The first and second electrodes 140a, 140b are electrically connected, or connectable, to an electrical system of the marine vessel 1. In this way, the first and second electrodes 140a, 140b are configured to pass electrical energy generated by the exchange of ions across the ion exchange interface 113 to the electrical system. That is, the charged electrolytes stored in the battery system 100 may be discharged by the flow battery 110 to provide electrical power to the electrical system. In other examples, the electrodes 140a, 140b are configured to pass electrical energy in the other direction, such as from an electrical supply connected to the electrodes 140a, 140b to an uncharged, or partially charged, electrolyte being passed through the ion exchange element 111. In this way, the battery system 100, and specifically the electrolyte contained therein, may be charged and/or discharged by electrically connecting the ion exchange element to an electrical load and/or an electrical supply, respectively.

In the illustrated example, the first and second conduit arrangements 120, 130 are mirrored. As such, like components in each of the first and second conduit arrangements 120, 130 are given like reference numerals, except that each reference numeral in the second conduit arrangement 130 is 10 integers higher than the corresponding reference numeral in the first conduit arrangement 120. As such, the battery system 100 is herein described primarily with reference only to the first conduit arrangement 120, with corresponding descriptions also applying to the second conduit arrangement 120.

In the illustrated example, the first conduit arrangement 120 comprises a first connection conduit 122c and a first valve 125a that is fluidically connected to the first ion exchange chamber 112a via the first connection conduit 122c. In other examples, the first valve 125a is provided directly at an end of the first ion exchange chamber 112a. For example, the ion exchange element 111 may comprise a first manifold (not shown) comprising the first valve 125a and/or the first connection conduit 122c. The first conduit arrangement 120 also comprises a first feed conduit 122a fluidically connected, or connectable, between the first ballast tank chamber 121a and the first ion exchange chamber 112a via the first valve 125a. The first conduit arrangement 120 further comprises a second feed conduit 122b fluidically connected, or connectable, between the second ballast tank chamber 121b and the first ion exchange chamber 112a via the first valve 125a. In other words, electrolyte is flowable from the first ballast tank chamber 121a to the ion exchange element 111 via the first feed conduit 122a and the first valve 125a, and/or from the second ballast tank chamber 121b to the ion exchange element 111 via the second feed conduit 122b and the first valve 125a. That is, the first valve 125a is operable to fluidically couple the first ballast tank chamber 121a and/or the second ballast tank chamber 121b to the first ion exchange chamber 112a.

The first conduit arrangement 120 also comprises a second connection conduit 123c and a second valve 125b that is fluidically connected to the first ion exchange chamber 112a via the second connection conduit 123c. In other examples, the second valve 125b is provided directly at an end of the first ion exchange chamber 112a. For example, the ion exchange element 111 may comprise a second manifold (not shown) comprising the second valve 125b and/or the second connection conduit 123c. The first conduit arrangement 120 also comprises a first return conduit 123a fluidically connected, or connectable, between the first ion exchange chamber 112a and the first ballast tank chamber 121a via the second valve 125b. The first conduit arrangement 120 further comprises a second return conduit 123b fluidically connected, or connectable, between the first ion exchange chamber 112a and the second ballast tank chamber 121b. In other words, electrolyte is flowable from the ion exchange element 111 to the first ballast tank chamber 121a via the second valve 125b and the first return conduit 123a, and/or from the ion exchange element 111 to the second ballast tank chamber 121b via the second valve 125b and the second return conduit 123b. That is, the second valve 125b is operable to fluidically couple the first ballast tank chamber 121a and/or the second ballast tank chamber 121b to the first ion exchange chamber 112a.

In this way, the first and second ballast tank chambers 121a, 121b are independently connected, or connectable, in parallel fluid loops with the ion exchange element 111. The first conduit arrangement 120 comprises a fluid pump 126 operable to cause the electrolyte to flow from one or both of the first and second ballast tank chambers 121a, 121b, through the first ion exchange chamber 112a, and back to the same, and/or the other, of the first and second ballast tank chambers 121a, 121b. That is, in some examples, electrolyte is flowable from one of the first and second ballast tank chambers 121a, 121b to the other of the first and second ballast tank chambers via the ion exchange element 111, such as to control an attitude and/or a stability of the marine vessel 1 as described hereinbefore. The fluid pump 126 is a reversible fluid pump 126, so that electrolyte is flowable in either direction through the first conduit arrangement 120. In the illustrated example, the fluid pump 126 is located in the second connection conduit 123c, but in other examples the pump 126 could instead be located in the first connection conduit 122c. Alternatively, one or more pumps 126 could be located elsewhere in the first conduit arrangement 120, such as in the first feed conduit 122a, the second feed conduit 122b, the first return conduit 123a, and/or the second return conduit 123b.

In operation, the electrolyte may be passed in a loop continuously from either or both of the first and second ballast tank chambers 121a, 121b, through the ion exchange element 111 and back the first and second ballast tank chambers 121a, 121b. This may cause a gradual discharging (or charging) of the electrolyte in the first and/or second ballast tank chambers 121a, 121b.

The first conduit arrangement 120 also comprises a transfer conduit 124 fluidically connected, or connectable, between the first and second ballast tank chambers 121a, 121b. The first conduit arrangement 120 also comprises a transfer pump 127 operable to pump electrolyte along the transfer conduit. That is, electrolyte is flowable between the first and second ballast tank chambers 121a, 121b via the transfer conduit 124, such as to control an attitude and/or stability of the marine vessel 1. The transfer pump 127 is a reversible transfer pump 127, so that electrolyte is flowable in either direction between the first and second ballast tank chambers 121a, 121b.

In some examples, the transfer conduit 124 and/or the transfer pump 127 is not provided. In such examples, the electrolyte is passable between the first and second ballast tank chambers 121a, 121b in any other suitable way, such as via the ion exchange element 111 as described hereinbefore, or via either one or both of the first and second valves 125a, 125b.

In other examples, either one of the first and second feed conduits 122a, 122b is not present. In some such examples, the first valve 125a and/or the first connection conduit 122c is not present. This may reduce a weight and/or complexity of the system, while ensuring the electrolyte is still passable from one of the ballast tank chambers 121a, 121b to the other, and from each of the ballast tank chambers 121a, 121b to the ion exchange element 111.

In other examples, either one of the first and second return conduits 122a, 122b is not present. In some such examples, the second valve 125a and/or the second connection conduit 122c is not present.

In other examples, the first conduit arrangement 120 may be configured either: without the first feed conduit 122a and without the second return conduit 123b; or without the second feed conduit 122b and without the first return conduit 123a. In such an example, either or both of the first and second valves 125a, 125b may be omitted. In this way, the first and second ballast tank chambers 121a, 121b are connected, or connectable, in series with the first ion exchange chamber 112a via the transfer conduit 124. This may further reduce the complexity and weight of the battery system 100, such as by reducing an amount of pipework required. In such a configuration, the battery system 100 may be configured to balance, in use, the amount of electrolyte passed between the first and second ballast tank chambers 121a, 121b via the transfer conduit 124 with that passed between the first and second ballast tank chambers 121a, 121b via the ion exchange element 111. This is to reduce a risk of an imbalance in an electrical charge of the electrolyte stored in the first ballast tank chamber 121a compared to that stored in the second ballast tank chamber 121.

In other examples, the first conduit arrangement 120 may be provided, or configured, either: without the first feed conduit 122a, without the second return conduit 123b and without the transfer conduit 124; or without the second feed conduit 122b, without the first return conduit 123a and without the transfer conduit 124. In this way, the first and second ballast tank chambers 121a, 121b are only fluidly connected, or connectable, to one another via the ion exchange element 111. In such an example, the electrolyte is passable back and forth through the ion exchange element 111, such as by the fluid pump 126, to charge or discharge the electrolyte, and/or to change an attitude of the vessel. It will be appreciated that in such an example, if the electrolyte is used to set a trim of the marine vessel 1, it may not be desirable, or possible, to pass the electrolyte through the ion exchange element 111 to charge or discharge the battery system 100.

It will be understood that the first conduit arrangement 120 may be configured in any other suitable way. It will also be understood that, in some examples, the first conduit arrangement 120 may be dissimilar to the second conduit arrangement 130. For example, the first conduit arrangement 120 could be configured as shown in FIG. 3, while the second conduit arrangement 130 is configured without one or more of the various conduits described hereinbefore. In some examples, electrolyte is flowable in different directions, or the same direction through the first and second conduit arrangements 120, 130. That is, the electrolyte may flow in opposite directions through the first and second ion exchange chambers 112a, 112b.

The battery system 100 shown in FIG. 3 also comprises a controller 150 communicatively coupled to components of the battery system 100. In some examples, the controller 150 is configured to cause operation of the first and second valves 125a, 125b and/or the fluid pump 126 and/or the transfer pump 127 of the first conduit arrangement 120, such as to cause electrolyte to be passed through the first conduit arrangement 120 in any of the ways described hereinbefore. The controller 150 may similarly cause operation of the corresponding components of the of the second conduit arrangement 130. In some examples, the controller 150 is configured to cause the battery system 100 to be discharged, such as by connecting the first and second electrodes 140a, 140b to an electrical load, such as an electrical system of the marine vessel 1. In other examples the controller 150 is configured to cause the battery system 100 to be charged, such as by connecting the first and second electrodes 140a, 140b to an electrical supply, such as a generator onboard the marine vessel 1, and/or an electrical grid connection at a port in which the marine vessel 1 is docked.

In some examples, the battery system 100 comprises one or more connections for fluidically connecting one or more of the ballast tanks 30a-30d and/or the respective ballast tank chambers 121a, 121b, 131a, 131b to a bunkering system for bunkering and/or debunkering electrolyte to and/or from the ballast tank chambers 121a, 121b, 131a, 131b. In this way, the battery system 100 may be charged by replacing the discharged electrolyte with pre-charged electrolyte from the bunkering system. The bunkering system may, for example, be a shore-based bunkering system, such as a bunkering system at a port at which the marine vessel 1 is docked, or it may be a sea-based bunkering system, such as a bunkering system and/or flow battery of another marine vessel 1 such as a bunker barge.

FIG. 4 shows an example method 400 of changing an attitude of the marine vessel 1. The method 400 comprises moving 410 electrolyte for the flow battery 110 from the first ballast tank chamber 121a to the second ballast tank chamber 121b. In some examples, the method 400 comprises moving 420 electrolyte through the ion exchange element 111 to charge or discharge the electrolyte. It will be appreciated that the two blocks 410, 420 shown in FIG. 4 may be performed in any order or simultaneously.

In some examples, the method 400 comprises discharging the flow battery by electrically connecting the ion exchange element to an electrical load, such as an electrical system of the marine vessel. In some examples, the method 400 comprises charging the flow battery by electrically connecting the ion exchange element to an electrical supply, such as a power generator of the marine vessel, or an electrical grid, such as during a port stay. In some examples, the ion exchange element comprises electrodes and the method 400 comprises connecting the electrical load and/or the electrical supply to the electrodes. In some examples, the charging and/or discharging the flow battery comprises moving electrolyte from one or both of the first and second ballast tank chambers to the ion exchange element and back to a respective one or both of the first and second ballast tank chambers.

In some examples, the method 400 comprises bunkering and/or debunkering electrolyte from the first and/or second ballast tank chambers, such as by connecting one or more of the ballast tanks 30a-30d and/or the respective ballast tank chambers 121a, 121b, 131a, 131b to a bunkering system as described hereinbefore.

In other examples, the method 400 comprises any other functions performed by the battery system 100 described hereinbefore. In some examples, the method 400 is performed by the controller 150 of the battery system 100 or any variant thereof discussed herein.

It will be appreciated that two or more of the above described examples may be combined, and that features of one example may be combined with features of one or more other examples.

Examples of the present invention have been discussed with particular reference to the examples illustrated. However, it will be appreciated that variations and modifications may be made to the examples described within the scope of the invention as defined in the appended claims.

1. A battery system for a marine vessel, the marine vessel comprising a hull, the battery system comprising:
a flow battery comprising an ion exchange element; and
a first ballast tank for location in the hull and defining a first ballast tank chamber for storing electrolyte for the flow battery.

2. The battery system of claim 1, comprising a first feed conduit through which the electrolyte is flowable from the first ballast tank chamber to the ion exchange element.

3. The battery system of claim 2 comprising:
a second ballast tank for location in the hull and defining a second ballast tank chamber for storing electrolyte for the flow battery; and
a first conduit arrangement through which electrolyte is flowable from the first ballast tank chamber to the second ballast tank chamber.

4. The battery system of claim 3, wherein the first conduit arrangement comprises the first feed conduit and a second feed conduit, and wherein the ion exchange element is fluidically connected or connectable to the first and second ballast tank chambers by the respective first and second feed conduits.

5. The battery system of claim 3, wherein the first conduit arrangement comprises a first transfer conduit configured so that electrolyte is flowable from the first ballast tank chamber to the second ballast tank chamber without passing through the ion exchange element.

6. The battery system of claim 3, comprising a first flow moving device operable to move electrolyte along the first conduit arrangement from the first ballast tank chamber to the second ballast tank chamber.

7. The battery system of claim 3, wherein the first conduit arrangement is configurable such that electrolyte is flowable from one of the first and second ballast tank chambers to the other of the first and second ballast tank chambers via the ion exchange element.

8. A hull assembly for a marine vessel, the hull assembly comprising a hull and the battery system of claim 3, wherein the first ballast tank is located in the hull.

9. The hull assembly of claim 8, wherein the second ballast tank is located in the hull, and wherein the first and second ballast tanks are located at opposite lateral sides of the hull or at opposite longitudinal ends of the hull.

10. The hull assembly of claim 8, comprising more than one flow battery.

11. A marine vessel comprising the battery system according to claim 1.

12. A method of changing an attitude of a marine vessel, the marine vessel comprising a hull, a flow battery, and first and second ballast tank chambers in the hull, the method comprising moving electrolyte for the flow battery from the first ballast tank chamber to the second ballast tank chamber.

13. The method of claim 12, wherein the flow battery comprises an ion exchange element, and the method comprises moving electrolyte for the flow battery from one or both of the first and second ballast tank chambers to the ion exchange element and back to the respective one or both of the first and second ballast tank chambers, to charge and/or discharge the electrolyte.

14. The method of claim 13, wherein the moving electrolyte for the flow battery from the first ballast tank chamber to the second ballast tank chamber comprises moving, using a first flow moving device, the electrolyte from the first ballast tank chamber to the second ballast tank chamber via a transfer conduit that is configured so that electrolyte is flowable from the first ballast tank chamber to the second ballast tank chamber without passing through the ion exchange element.

15. The method of claim 13, wherein the moving electrolyte for the flow battery from the first ballast tank chamber to the second ballast tank chamber comprises moving the electrolyte from the first ballast tank chamber to the second ballast tank chamber via the ion exchange element.
